(19) United States
(12) Patent Application Publication
(10) Pub. No.: US 2012/0235536 A1
(43) Pub. Date: Sep. 20, 2012

(54) Conductive Device For a Brush Motor

(76) Inventor: Tong-Lung Chang, New Taipei City (TW)

(21) Appl. No.: 13/047,582

(22) Filed: Mar. 14, 2011

(51) Int. Cl. H01R 39/28

(52) U.S. Cl. 310/238

(57) ABSTRACT

A conductive device for a brush motor has an insulation stand, a conductive sheet and a conductive wheel. The insulation stand has an open end, a closed end, a supporting rod and a power cord. The supporting rod is mounted in the insulation stand near the open end. The power cord is mounted in the insulation stand and has an outer end extending out of the closed end of the insulation stand. The conductive sheet is curved, is mounted in the insulation stand at the open end around the supporting rod and has a middle and two ends. The conductive wheel is a hollow wheel, is rotatably connected to the insulation stand and has an elastic layer and a conductive layer. The elastic layer is mounted around the supporting rod. The conductive layer is mounted around the elastic layer and contacts the conductive sheet.

### BACKGROUND OF THE INVENTION

1. Field of the Invention

The present invention relates to a conductive device, and more particularly relates to a conductive device for a brush motor to reduce the abrasion loss and the noise of the brush motor and to prolong the life of the brush motor.

2. Description of Related Art

Conventional motors include brush motors and non-brush motors. Conventional brush motors have the advantages of low cost, low rotation speed and high torsion and are usually used on the electric hand tools and the food conditioning machines.

With reference to FIGS. 5 to 8, a conventional brush motor 60 in accordance with the prior art comprises a casing 61, a stator 62, a rotor 63 and two conductive devices 70. The casing 61 has a top, a bottom, an internal surface and a chamber. The chamber is formed in the casing 61 between the top and the bottom of the casing 61. The stator 62 is a permanent magnet and is mounted on the internal surface of the casing 61.

The rotor 63 is rotatably connected to the casing 61 and has a driving axle 631, a silicon steel lamination 632 and a commutator 633. The driving axle 631 is rotatably connected to the casing 61 and has an external surface and two ends respectively extending out of the top and the bottom of the casing 61. The silicon steel lamination 632 is mounted in the chamber of the casing 61, is securely mounted around the external surface of the driving axle 631 inside the stator 62 and has an external surface and multiple coils. The coils are mounted on the external surface of the silicon steel lamination 632. The commutator 633 is securely mounted around the external surface of the driving axle 631 between the top of the casing 61 and the silicon steel lamination 632 and has an insulating layer and multiple conductive sheets. The insulating layer is mounted in the commutator 633 and has an external surface. The conductive sheets are mounted on the external surface of the insulating layer at intervals and are respectively and electrically connected to coils of the silicon steel lamination 632.

The conductive devices 70 are mounted on the casing 61 beside the commutator 633 and align with each other, and each conductive device 70 has an insulation stand 71, an electrical brush 72 and a spring 73. The insulation stand 71 is hollow, is mounted on the casing 61 and has an open end and a closed end. The open ends of the insulation stands 71 face to the commutator 633. The electrical brush 72 is a rectangular block, may be made of graphite or copper, is mounted in the insulation stand 71 and has an outer end and an inner end. The outer end of the electrical brush 72 extends out of the open end of the insulation stand 71 and contacts the commutator 633. The inner end of the electrical brush 72 is mounted in the insulation stand 71 and faces the closed end of the insulation stand 71. The spring 73 is mounted in the insulation stand 71 and has two ends respectively connected to the closed end of the insulation stand 71 and the inner end of the electrical brush 72 to push the outer end of the electrical brush 72 to contact the commutator 633.

In use, the electrical brush 72 is electrically connected to a power source to provide an electric power to the commutator 633 and the coils on the silicon steel lamination 632 will produce a magnetic force by the magnetic effect of electric current. Then, the rotor 63 will be rotated with the magnetic force repelled by the stator 62.

However, the conductive device 70 of the conventional brush motor 60 has the following shortcomings.

1. The electrical brush 72 is rubbed against the commutator 633 by the spring 73 and this will increase the abrasion loss of the electrical brush 72 and shorten the life of the electrical brush 72.

2. The carbon powder or the bronze powder formed by the friction between the electrical brush 72 and the commutator 633 will accumulate and stuff in the intervals between the conductive sheets of the commutator 633 to electrically connect the conductive sheets with each other and this will cause a power interruption in the brush motor 60 and shorten the life of the commutator 633.

3. When the electrical brush 72 has been worn off and torn to non-contact with the commutator 633, an electric arc of the electric current will be generated between the electrical brush 72 and the commutator 633 and the electric arc will form an oxide layer on the conductive sheets of the commutator 633. Then, the resistance and the heat energy of the commutator 633 will be increased and to eliminate the heat energy of the commutator 633 becomes difficult.

4. When the conventional brush motor 60 is in use, the friction between the electrical brush 72 and the commutator 633 will cause a noise.

To overcome the shortcomings, the present invention provides a conductive device for a motor to mitigate or obviate the aforementioned problems.

### SUMMARY OF THE INVENTION

The main objective of the present invention is to provide a conductive device for a brush motor that can reduce the abrasion loss and the noise of the brush motor and can lengthen the life of the brush motor.

The conductive device for a brush motor in accordance with the present invention has an insulation stand, a conductive sheet and a conductive wheel. The insulation stand has an open end, a closed end, a supporting rod and a power cord. The supporting rod is mounted in the insulation stand near the open end. The power cord is mounted in the insulation stand and has an outer end extending out of the closed end of the insulation stand. The conductive sheet is curved, is mounted in the insulation stand at the open end around the supporting rod and has a middle and two ends. The conductive wheel is a hollow wheel, is rotatably connected to the insulation stand and has an elastic layer and a conductive layer. The elastic layer is mounted around the supporting rod. The conductive layer is mounted around the elastic layer and contacts the conductive sheet.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a conductive device for a brush motor in accordance with the present invention;

FIG. 2 is an exploded perspective view of a brush motor with two conductive devices in FIG. 1;

FIG. 3 is a side view in partial section of the brush motor with the conductive devices in FIG. 2;

FIG. 4 is an enlarged top view in partial section of the brush motor with the conductive devices in FIG. 2;

FIG. 5 is a perspective view of a conventional brush motor in accordance with the prior art;

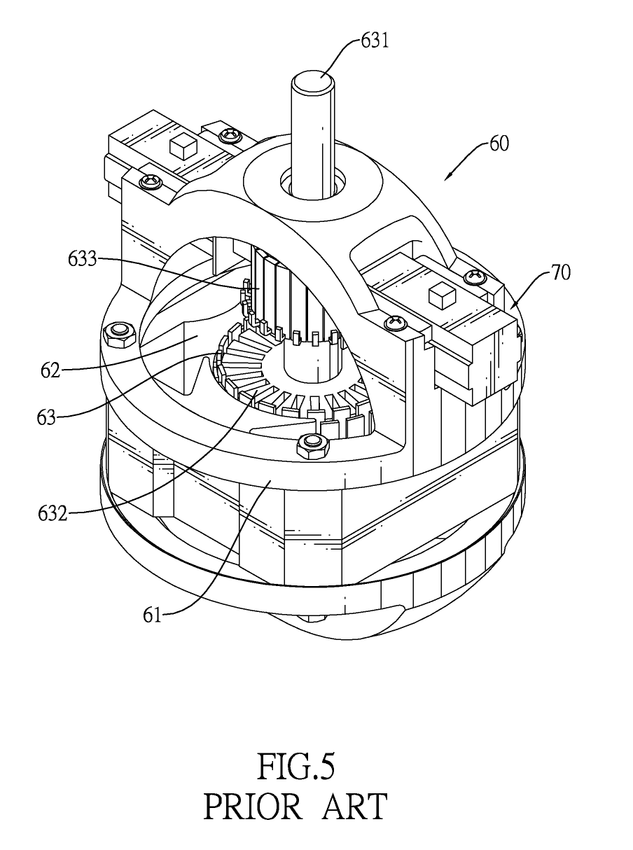

FIG. 6 is an exploded perspective view of the conventional brush motor in FIG. 5;

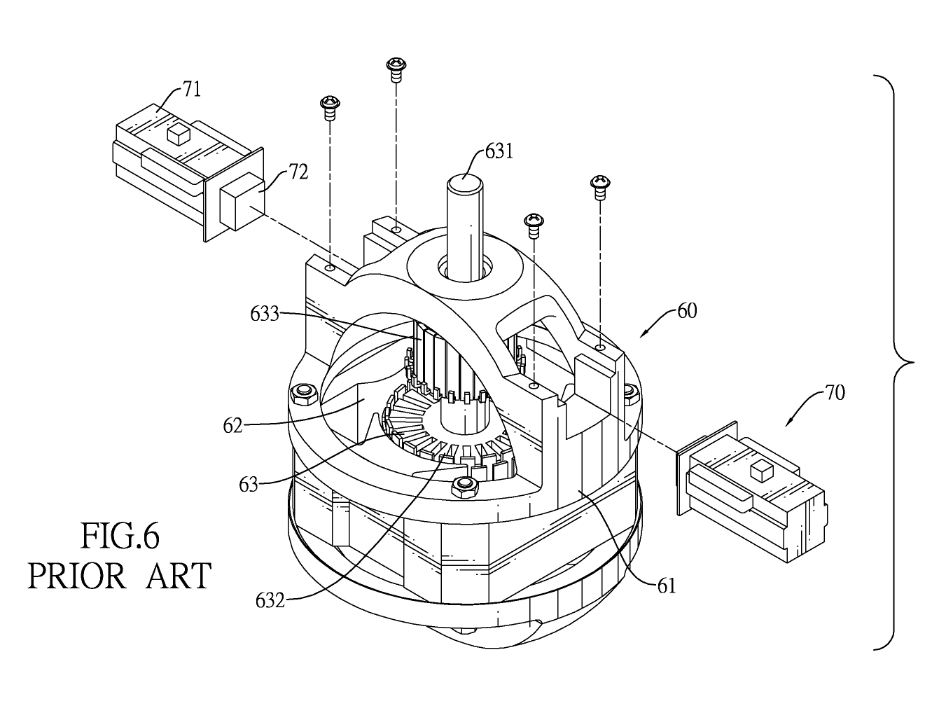

FIG. 7 is a side view in partial section of the conventional brush motor in FIG. 5; and

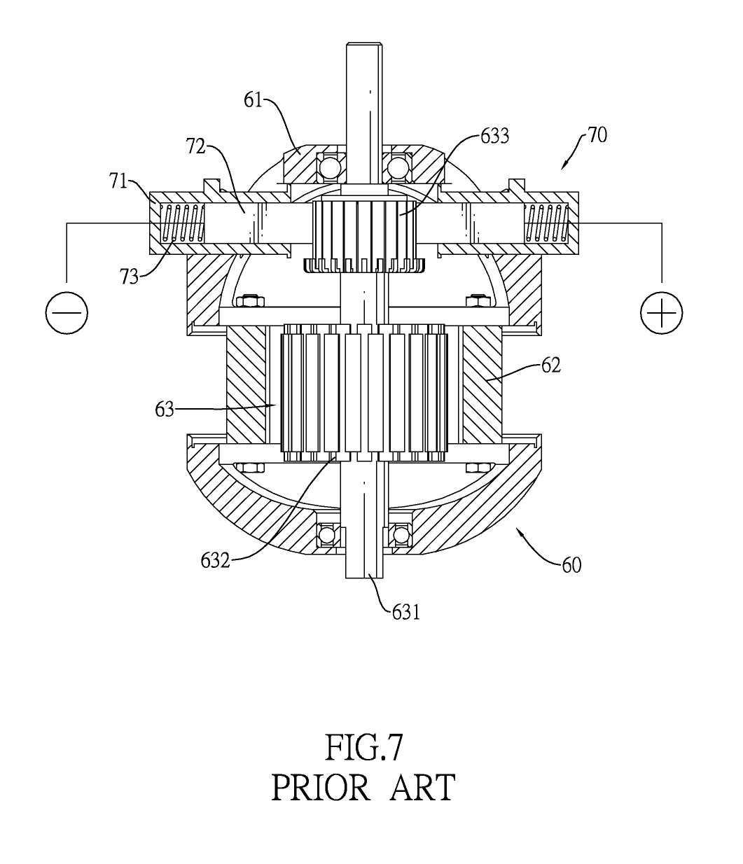

FIG. 8 is an enlarged top view in partial section of the conventional brush motor in FIG. 5.

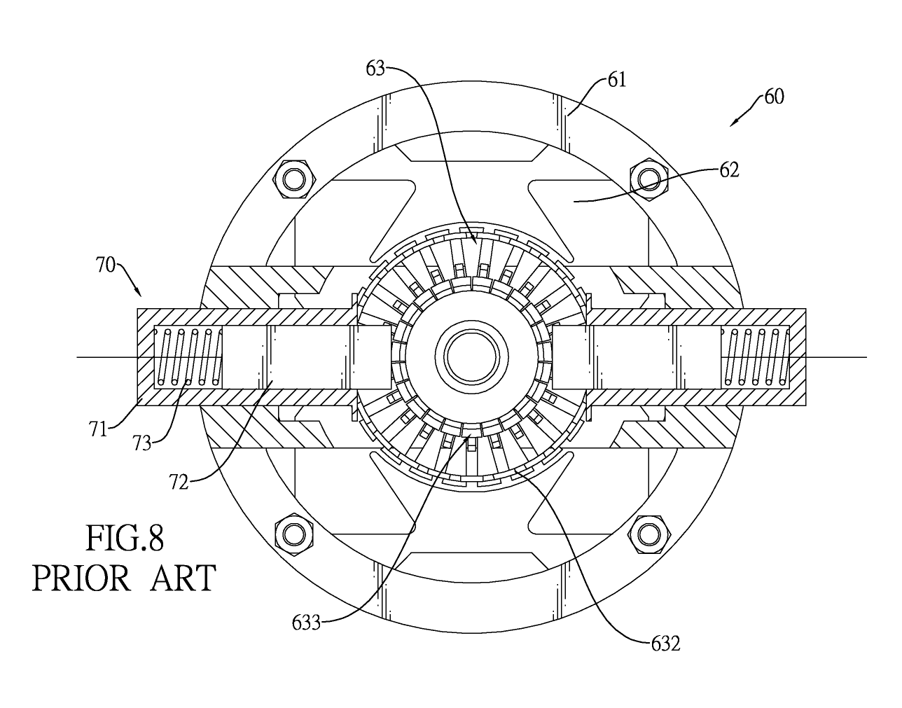

### DETAILED DESCRIPTION OF THE PREFERRED EMBODIMENT

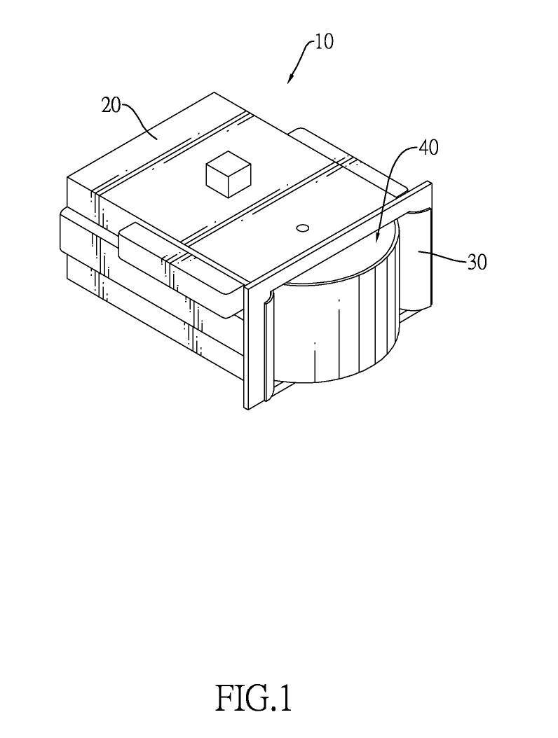

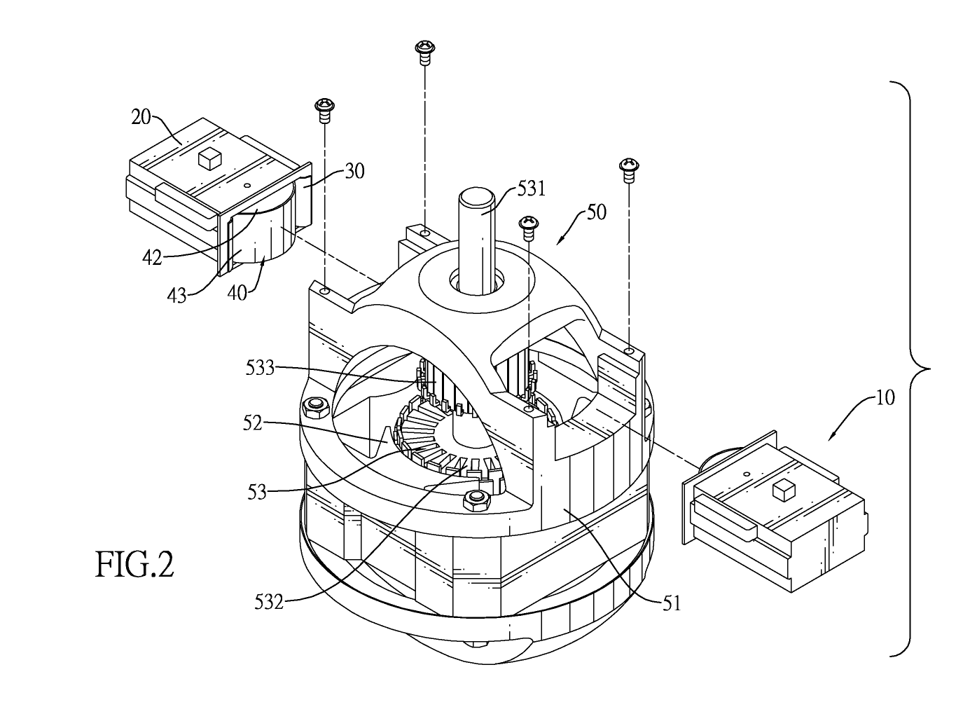

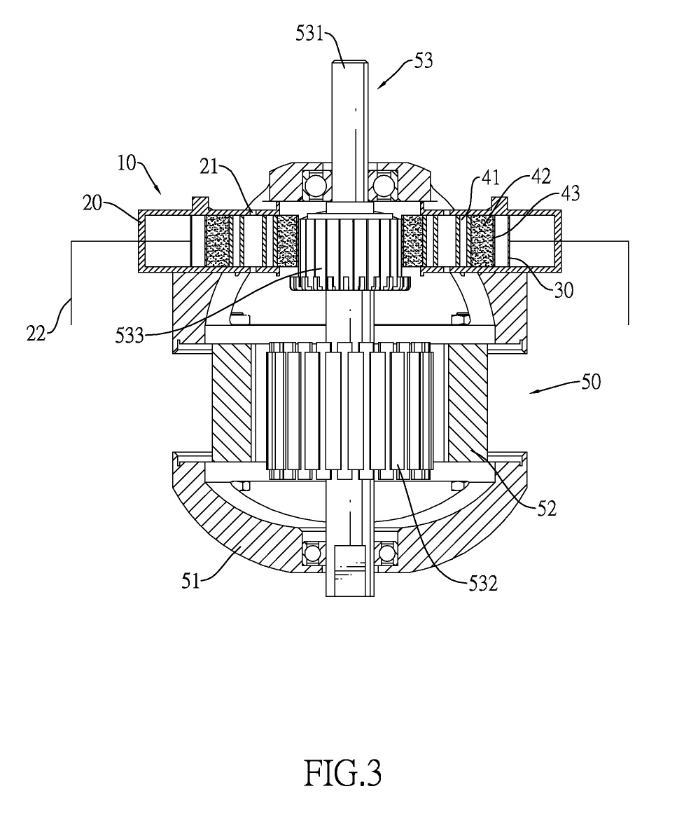

With reference to FIGS. 1 to 4, a conductive device 10 in accordance with the present invention is applied to a brush motor 50 having a casing 51, a stator 52 and a rotor 53. The casing 51 has a top, a bottom, an internal surface and a chamber. The chamber is formed in the casing 51 between the top and the bottom of the casing 51. The stator 52 is a permanent magnet and is mounted on the internal surface of the casing 51.

The rotor 53 is rotatably connected to the casing 51 and has a driving axle 531, a silicon steel lamination 532 and a commutator 533. The driving axle 531 is rotatably connected to the casing 51 and has an external surface and two ends respectively extending out of the top and the bottom of the casing 51. The silicon steel lamination 532 is mounted in the chamber of the casing 51, is securely mounted around the external surface of the driving axle 531 inside the stator 52 and has an external surface and multiple coils. The coils are mounted on the external surface of the silicon steel lamination 532. The commutator 533 is securely mounted around the external surface of the driving axle 531 between the top of the casing 51 and the silicon steel lamination 532 and has an insulating layer and multiple conductive sheets. The insulating layer is mounted in the commutator 533 and has an external surface. The conductive sheets are mounted on the external surface of the insulating layer at intervals and are respectively and electrically connected to coils of the silicon steel sheet 532.

The conductive device 10 is connected to the brush motor 50, is mounted on the casing 51 beside the commutator 533 and has an insulation stand 20, a conductive sheet 30 and a conductive wheel 40. The insulation stand 20 may be a rectangular and hollow box, is made of an insulating material and is mounted on the casing 51. The insulation stand 20 has an open end, a closed end, a supporting rod 21 and a power cord 22. The open end of the insulation stand 20 faces to the commutator 533. The supporting rod 21 is mounted in the insulation stand 20 near the open end of the insulation stand 20. The power cord 22 is mounted in the insulation stand 20 and has an outer end extending out of the closed end of the insulation stand 20.

The conductive sheet 30 is curved, is made of an elastic conductive metal and is mounted in the insulation stand 20 at the open end of the insulation stand 20 around the supporting rod 21 and has a middle and two ends. The middle of the conductive sheet 30 is mounted in the insulation stand 20 and is electrically connected to the power cord 22. The ends of the conductive sheet 30 extend out of the open end of the insulation stand 20 and face to each other.

The conductive wheel 40 is a hollow wheel, is rotatably connected to the insulation stand 20, contacts the commutator 533 and has a bearing 41, an elastic layer 42 and a conductive layer 43. The bearing 41 is mounted in the conductive wheel 40, is mounted around the supporting rod 21 of the insulation stand 20 and has an external surface. The elastic layer 42 may be a rubber layer, is mounted around the external surface of the bearing 41, extends out of the open end of the insulation stand 20 between the ends of the conductive sheet 30 and has an external surface. The conductive layer 43 may be an elastic metal layer, is mounted around the external surface of the elastic layer 42 and contacts the conductive sheet 30 and the commutator 533.

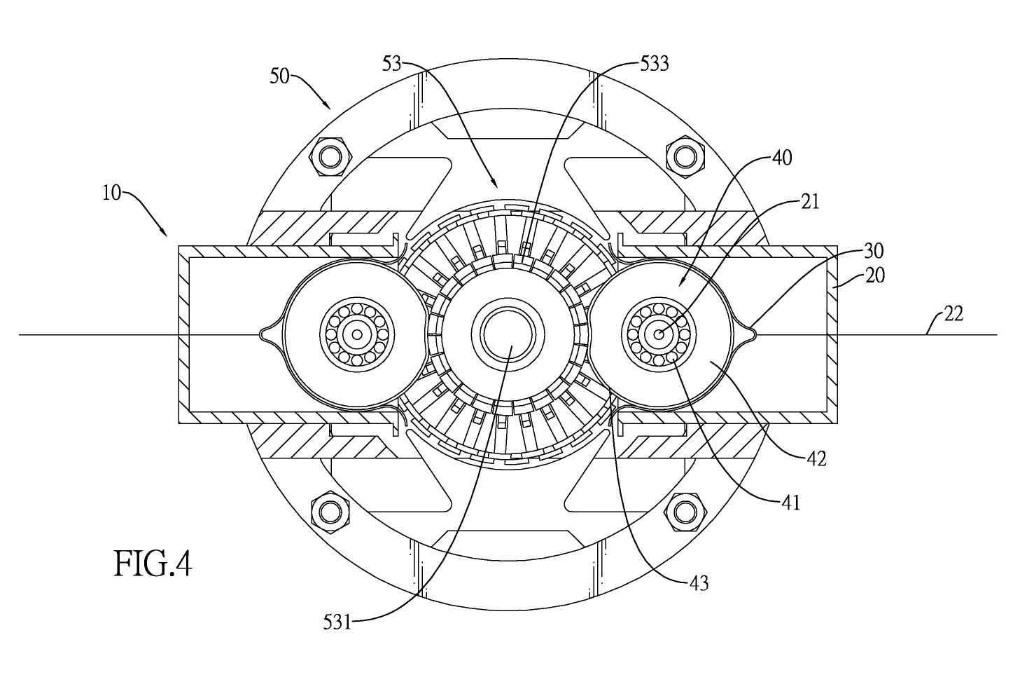

With reference to FIG. 4, two conductive devices 10 are mounted on the brush motor 50 in use, and the power cords 22 of the conductive devices 10 are respectively connected to the power sources with different electrodes. The powers are transmitted to the conductive wheels 40 via the power cords 22 and the conductive sheets 30. The conductive sheets 30 are respectively contacted with the conductive wheels 40 near the ends to increase the area of the electric current passing through and this can allow the electric current to transmit smoothly and can avoid the power interruption. When the electric current is transmitted to the commutator 533 via the conductive wheels 40, the coils will produce a magnetic force by the magnetic effect of electric current. Then, the rotor 53 will rotate with the magnetic force repelled by the stator 52 and the commutator 533 will rotate with the rotor 53. When the commutator 533 rotates with the rotor 53, the conductive wheels 40 that contact the commutator 533 will rotate in the contrary rotating direction relative to the commutator 533.

In addition, the diameter of the conductive wheel 40 of the conductive device 10 in accordance with the present invention can be designed to be different from the diameter of the commutator 533 and this can prevent the conductive wheels 40 from contacting and rubbing against the commutator 533 at the same region. Furthermore, the elastic layer 42 of the conductive wheel 40 is mounted between the bearing 41 and the conductive layer 43 and this can provide a suitable pressure between the conductive layer 43 and the commutator 533 to reduce the abrasion loss of the conductive wheels 40 and the life of the conductive wheels 40 can be prolonged. In addition, with the suitable pressure between the conductive layer 43 and the commutator 533, the electric current also can be transmitted in the brush motor 50 favorably and can avoid the power interruption. Additionally, when the abrasion loss of the conductive wheels 40 is reduced, chips formed by the friction between the conductive wheels 40 and the commutator 533 will decrease and this can prevent the brush motor 50 from short-circuiting and can reduce the noise of the motion of the brush motor 50.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A conductive device for a brush motor comprising:
an insulation stand having:
an open end;
a closed end;
a supporting rod mounted in the insulation stand near the open end of the insulation stand; and
a power cord mounted in the insulation stand and having an outer end extending out of the closed end of the insulation stand;
a conductive sheet being curved, mounted in the insulation stand at the open end of the insulation stand around the supporting rod and having:
a middle mounted in the insulation stand and electrically connected to the power cord; and
two ends extending out of the open end of the insulation stand and facing to each other; and
a conductive wheel being a hollow wheel, rotatably connected to the insulation stand and having:
an elastic layer mounted around the supporting rod of the insulation stand, extending out of the open end of the insulation stand between the ends of the conductive sheet and having an external surface; and
a conductive layer mounted around the external surface of the elastic layer and contacting the conductive sheet between the ends of the conductive sheet.

2. The conductive device for a brush motor as claimed in claim 1, wherein the conductive wheel has a bearing mounted in the conductive wheel, mounted around the supporting rod of the insulation stand and having an external surface; and wherein the elastic layer is mounted around the external surface of the bearing.

3. The conductive device for a brush motor as claimed in claim 2, wherein the conductive layer is an elastic metal layer.

4. The conductive device for a brush motor as claimed in claim 3, wherein the elastic layer is a rubber layer.

5. The conductive device for a brush motor as claimed in claim 4, wherein the insulation stand is made of an insulating material.

6. The conductive device for a brush motor as claimed in claim 1, wherein the conductive layer is an elastic metal layer.

7. The conductive device for a brush motor as claimed in claim 1, wherein the elastic layer is a rubber layer.

8. The conductive device for a brush motor as claimed in claim 1, wherein the insulation stand is made of an insulating material.
